(19) United States
(12) Patent Application Publication
(10) Pub. No.: US 2004/0036310 A1
(43) Pub. Date: Feb. 26, 2004

(54) Support assembly for a vehicle dashboard

(76) Inventor: Michael John Mills, Warwickshire (GB)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/297,859

(22) PCT Filed: Jun. 7, 2001
(86) PCT No.: PCT/GB01/02496

(30) Foreign Application Priority Data
Jun. 7, 2000 (GB) 0013725.7

(51) Int. Cl. B62D 25/14

(52) U.S. Cl. 296/72

(57) ABSTRACT

A support assembly for a vehicle dashboard comprises a support beam having end faces. As seen from the end faces, in cross-section the support beam has five side faces, a forward face, upper face, lower face, upper rearward face, and lower rearward face. The upper face, lower face, upper rearward face and lower rearward face are each provided with a corresponding groove. The grooves are disposed peripherally of the support beam and each groove extends longitudinally of the support beam to support at least one dashboard module in a selected one of a plurality of positions. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### BACKGROUND OF THE INVENTION

1. Field of the Invention

This invention relates to a support assembly for a vehicle dashboard.

2. Description of the Related Art

It is known to provide support assemblies comprising support beams for vehicle dashboards which extend transversely of the vehicle to support the dashboard and to provide a mount for an instrument panel, air bag, trim for example. Such support beams are engineered for a specific vehicle, to accommodate the instrument panel etc. at a specific location.

### SUMMARY OF THE INVENTION

An aim of the invention is to provide a new [symbol] panel.

According to a first aspect of the present inven [symbol] for a vehicle dashboard comprising a support beam said [symbol] of grooves disposed peripherally of said beam with each [symbol] of the support beam to support at least one dashboard module in a selected one of a plurality of positions.

As a result the support beam is able to accommodate and support at least one dashboard module in different positions and so may be used in more than one vehicle type.

At least one of said grooves may be T-shaped in cross-section, or may be dove-tailed in cross-section or any other cross-section as appropriate.

Each groove may be of the same cross-section.

The beam may comprise at least three grooves.

The beam may comprise an extruded profile. The extruded profile may be hollow, and filled with a foam material to provide additional stiffness.

The extruded profile preferably comprises a polymer material provided with reinforcing fibers. Alternatively, the extruded profile may comprise a light metal or alloy, for example aluminum.

The beam may be polygonal in cross-section, with said grooves provided in a plurality of sides of said polygon. In cross-section, the support beam may have five sides, comprising a forward side, a top side, a bottom side, a first rearward side and a second rearward side wherein grooves are provided on the top, bottom and rearward sides.

The support assembly may comprise mounting means having a first part for attachment to a vehicle body in engagement with said support beam.

The mounting means may comprise a plurality of tags each adapted to engage a corresponding groove of said beam.

The mounting means may have a forward face which is generally coplanar with the forward side of said support beam.

The support assembly may comprise a dashboard module wherein said dashboard module comprises with at least one tag to be received in one of said grooves.

The module may be disposed at a desired location longitudinal on the beam by engaging the tag with a corresponding groove in a longitudinal direction and sliding the module relative to the beam until the module is in its desired position.

The module may be attached to the beam when said module is in its desired position. The module may be attached by for example high frequency welding vibration bonding, riveting or by use of adhesive or by any other means as desired.

The dashboard module may comprise a contact surface to engage a face of said beam.

The contact surface may be provided or a flange adjacent to a tag.

The dashboard module may be shaped to provide energy absorption properties.

To provide energy absorption properties, the dashboard module may comprise a first connecting part provided with a tag to engage one of said groove, and a second connecting pail, for example to support trim, an intermediate part located between the first connecting part and the second connecting, wherein the first connecting part is connected to the intermediate part by a forward pair of arms and the second connecting part is connected to the intermediate part by a rearward pair of arms.

The dashboard modules may be made by molding, or extrusion or by any other means as desired, and may comprise polymer or an alloy material.

The dashboard module may comprise a cavity, said cavity may be filled with a foam material to increase the strength of the module.

Said dashboard module may comprise an instrument support bracket, a ventilation support bracket, a steering column support bracket, an air bag support, a glove box support or a structural bracket to engage a part of vehicle, or any other module as desired.

According to a second aspect of the invention, we provide a method of making a support assembly comprising the steps of providing a support beam comprising a plurality of grooves disposed peripherally and extending longitudinally of said support beam, providing at least one dashboard module comprising at least one tag, engaging the or each tag with a corresponding groove in a longitudinal direction and sliding the dashboard module relative to the beam until the dashboard module is in its desired position.

The method may comprise the step of providing a said support beam of a desired length before or after providing said at least one dashboard module.

The method may comprise the step of providing said support beam of a desired length by cutting a stock beam to the desired length.

The method may comprise fixing the dashboard module to the support beam when said dashboard module is in its desired position.

The method may comprise providing mounting means having a first part in engagement with said support beam and a second part for attachment to a vehicle body.

The method may comprise the step of attaching said mounting means to a vehicle body.

### BRIEF DESCRIPTION OF THE DRAWINGS

The invention will now be described by way of example only with reference to the accompanying drawings wherein;

FIG. 1 is a perspective view of a support assembly according to the present invention, and

FIG. 2 is a view of an alternative configuration of the support assembly of FIG. 1.

### DESCRIPTION OF THE PREFERRED EMBODIMENT

Referring now to the Figures, a support assembly is shown at 10, comprising a support beam 11 having end faces 12. As seen from the end faces 12, in cross-section the support beam 11 in the present example has five side faces, a forward face 13, upper face 14, lower face 15, upper rearward face 16 and lower rearward face 17. The upper face 14, lower face 15, upper rearward face 16 and lower rearward face 17 are each provided with a corresponding groove 14a, 15a, 16a, 17a. The grooves 14a, 15a, 16a, 17a are disposed peripherally of the beam.

In the present example “forward” and “rearward” refer, when the support assembly is mounted in a forward part of a passenger compartment of a vehicle, to the directions forwardly of the vehicle and rearwardly of the vehicle, i.e. away from and towards the passenger compartment respectively.

In the present example, the grooves 14a, 15a, 16a, 17a are generally T-shaped, although the grooves may be dove-tailed or of any other shape as desired. The grooves 14a, 15a, 16a, 17a extend longitudinally of the respective face 14, 15, 16, 17 along the length of beam 11.

The support beam 11 in the present example is hollow having a longitudinally extending aperture 18. The aperture 18 is filled with a foam material 19 for additional stiffness.

Although the beam in the present example is shown as polygonal in cross-section, and in particular pentagonal, in cross section, it will be apparent that the beam may have any cross section as desired. The beam may have any number of grooves as desired, preferably at least two, more preferably at least three, to accommodate modules in a desired on one of a plurality of orientations.

Preferably, the support beam 11 comprises an extrusion. Forming the beam 11 by extrusion is particularly appropriate since the beam has a constant cross-section along its length. Further, since the beam 11 may be cut to any length as desired, it can thus be adapted to be located in any desirable vehicle body of any width simply by cutting the support beam to length. The support beam 11 may comprise a polymer material, preferably provided with reinforcing fibers, or may comprise a light metal, e.g. aluminum or alloy material if desired.

To maintain the support beam 11 in place in a vehicle, the support assembly 10 comprises mounting means 20. In the present example, the mounting means 20 each comprise a downwardly extending first part 21 having an abutment face 21 a and apertures 22 to receive fastening means to attach the mounting means 20 to a part of a vehicle body, particularly a vehicle body in white, and a second pail 23 disposed above the first part 22. The second pail 23 comprises an inner face 24 adapted to embrace the upper face 14, upper rearward face 16, lower rearward face 17 and lower face 15 of the support beam 10. The inner face 24 further comprises tags 24a, 24b, 24c, 24d which are received in the grooves 14a, 15a, 16a, 17a, respectively. The support beam 11 is thus firmly held in engagement with the second part 23 of the mounting means 20. The forward face 13 of tile support beam 11 and the abutment face 21 a of the mounting means 20 are preferably generally coplanar, to facilitate mounting of the support assembly 10 on a vehicle body.

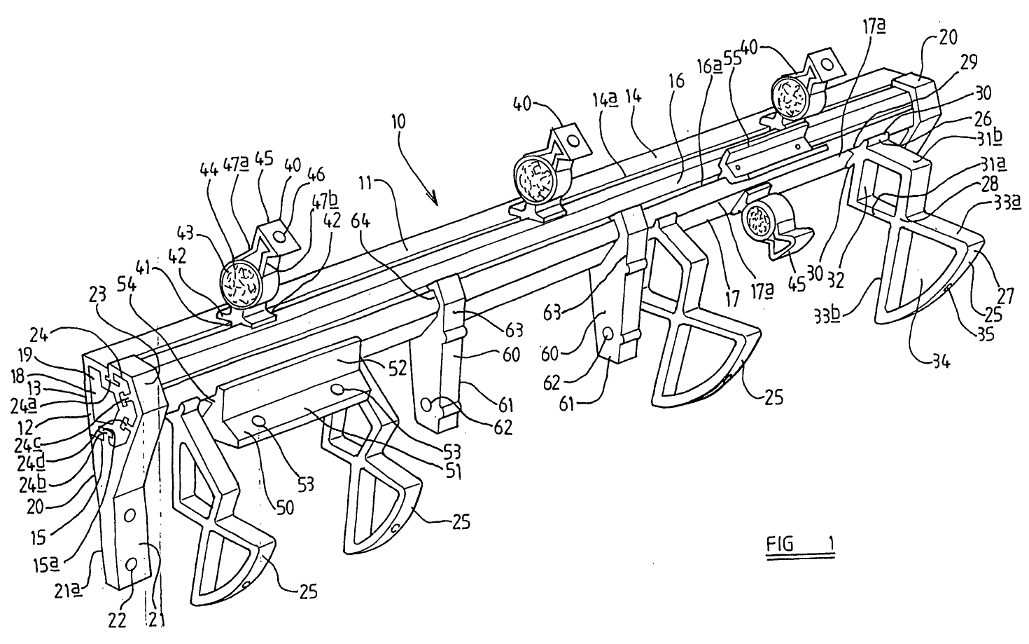

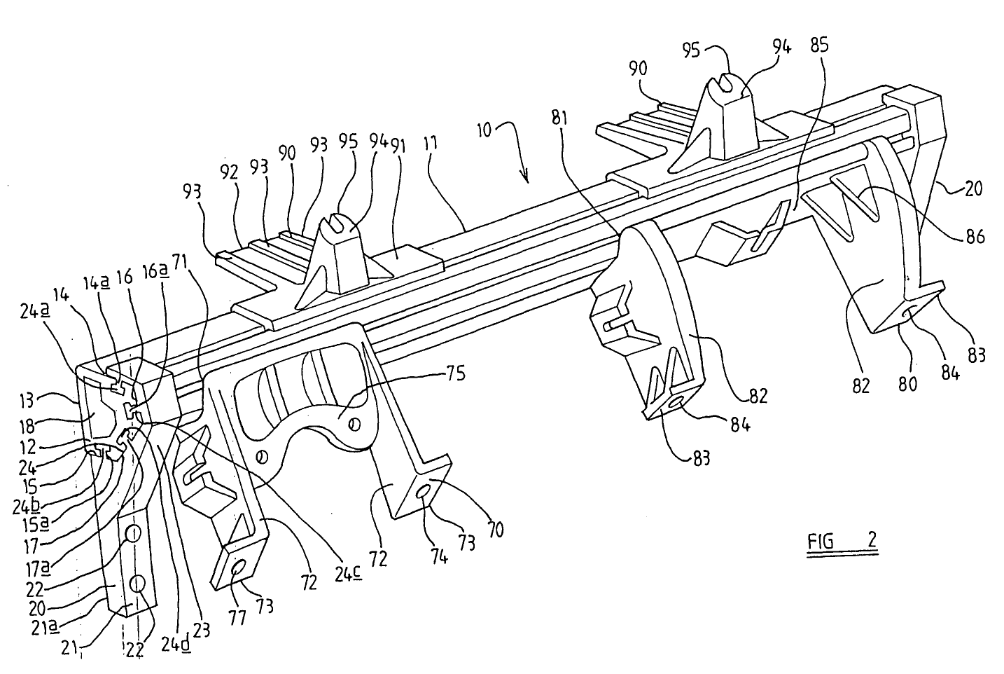

The shape of the support beam 11 is thus highly adaptable and can receive one or more dashboard modules to provide support for any desired elements to be supported oil the beam, for example a steering column, a glove box, ventilation means, an instrument panel and so on. Such modules are shown in FIGS. 1 and 2 and are discussed in more detail below.

Referring to FIG. 1, general purpose support brackets are shown at 25, comprising a first connection pail 26, a second part 27 spaced from said connection part 26, and an intermediate part 28. The first connection part 26 is provided with a tag 29, received in the present example in groove 17a of the support beam 11, and contact surfaces comprising flanges 30 disposed either side of the tag 29 which engage the lower rearward face 17 of support beam 11 to minimize relative movement between the bracket 27 and the support beam 11. The first connection part 26 is connected to the intermediate part 28 by forward arms 31a, 31b. The arms 31a, 31b are angularly shaped such that they define a four sided aperture 32. The second support pail 25 is connected to the intermediate part 28 by rearward arms 33a, 33b. The rearward arms 33a, 33b and the second connection part 25 define a sector shaped aperture 34.

The brackets 25 thus shaped provide energy absorbing properties, and can be tuned to provide the desired energy absorption. In the present example, the forward arms 31a, 31b in particular will flex to absorb the energy of an impact, in the position shown in FIG. 1 particularly of a passenger's knee. The second connection pail 27 is provided with apertures 35 to receive fastening means to attach desired elements thereto, for example an instrument panel, dashboard casing or any other elements as required. In the example shown in FIG. 1, the left hand pair of general support brackets 25 is located to provide support for an instrument panel, whilst the right hand pair of brackets 25 are disposed to provide support for a glove compartment. The general support brackets 25 preferably comprise an injection molded or extruded polymer material.

Casing support brackets are generally indicated at 40, three of said casing support brackets; 40 being disposed adjacent to the upper face 16 of the support beam 11 and one being disposed adjacent to the lower rearward face 17 of the support beam 11. Each casing support bracket 40 is provided with a tag 41 to be received in a groove of the support beam 11 and flanges 42 disposed either side of the tag 41 to engage the responding face of the beam 11. The tag 41 is connected to a generally cylindrical intermediate part 43, the cavity of which is filled with a foam material 44 to provide increase structural strength. A connection part 45 is provided with an aperture 46 to receive fastenings for connecting a casing thereto, connected to the cylindrical intermediate part 43 by arms 47a, 47b. Each of the arms 47a, 47b is generally angular in cross section, each having an inwardly directed elbow located pail way between the connection pail 45 and the cylindrical intermediate part 43.

A steering panel support bracket is generally indicated at 50 comprising a rearwardly directed flange 51 and an upwardly extending part 52. The flange 51 is provided with aperture 53 to receive fastening means for steering column. The steering column support bracket 50 has a rearward face 54 provided with tags (not shown) received in groove 15a of the lower face 15 and groove 17a of the lower rearward face 17. The forward face 54 is further shaped to engage the lower face 15 and lower rearward face 17 of the beam 11 to provide a rigid connection between the steering column support bracket 50 and the beam 11. The steering column support bracket 50 comprises molded aluminum or polymer as desired, and are relatively stiff compared to the general purpose support brackets 25.

An airbag support bracket is shown at 55, comprising a channel-shaped part 56 and a tag 57 received in groove 16a of the upper rearward face 16, such that the channel-shaped pail 55 is directed rearwardly and upward of the support assembly 10.

Ventilation support brackets are generally shown at 60 to provide support for a heating/ventilation/air conditioning (HVAC) module. Each ventilation support bracket 60 comprises a downwardly extending part 61 provided with an aperture 62 to receive fastening means to engage the HVAC module. An upper pail 63 of each ventilation support bracket 60 is provided with tags to be received in at least groove 16a of the upper rearward face 16 and groove 15a of the lower face 15. The upper pail 63 has an inner face 64 shaped to engage at least in part the upper rearward face 16, lower rearward face 16 and lower face 15 of the beam 1. The support brackets 60 are disposed at the appropriate spacing to receive a HVAC module.

The ventilation support brackets 60 may comprise molded aluminum or polymer or any other materials as desired and are relatively stiff compared to the general purpose support brackets 25.

Referring now to FIG. 2, a combined steering column and instrument panel casing support is shown at 70. The combined support 70 has a forward face 71 provided with tags to engage at least the grooves 16a, 15a. The forward face 71 is shaped to engage at least partly the upper rearward face 16, lower rearward face 17 and lower face 15 of the support beam 11. The combined support 70 has a pair of generally parallel side members 72 extending rearwardly and downwardly of the support beam 11, each provided at their free end with an outwardly directed flange 73 having an aperture 74 therein. Disposed between the side members 72 is an instrument panel support 75 to receive an instrument panel and casing.

A combined glove box and instrument panel casing support is shown generally at 80. As in the combined steering column support 70, the combined glove box support 80 comprises a forward face 81 provided with tags (not shown) to engage at least grooves 16a, 17a. The forward face 81 is shaped to engage faces 16, 17 of the support beam 11 to ensure a rigid fit between the support beam 11and combined glove box support 80. The combined glove box support 80 comprises a pair of spaced generally parallel arms 82 extending rearwardly and downwardly of the support beam 11, provided at their free ends with outwardly directed flanges 83, each provided with an aperture 84 for suitably fastening means. The generally parallel arms 82 are interconnected by a back plate 85 and provided with suitable stiffening means 86. The combined glove box support 80 may comprise alloy or a reinforced polymer or any other appropriate material as desired.

To provide additional strength to the beam assembly 10, strengthening brackets 90 may be provided. The strengthening brackets 90 may be provided with a tag to be received in the groove 14a of the upper face 14, and may comprise a flange part 91 to engage a forward part of the upper face 14. Projecting forwardly from the flange pail 91 is a connecting part 92, provided with reinforcing ridge parts 93. The connecting part 92 engages an appropriate part of the vehicle structure, for example a windscreen rail and may be connected thereto to provide additional support for the support beam assembly 10. Each strengthening bracket 90 further comprises an upstanding part 94 having a slot 95 provided in an upper pail thereof to support, for example, an instrument panel casing. The strengthening brackets 90 may comprise alloy or reinforced polymer or any other material as desired.

In assembling a support assembly 10, a stock beam is first cut to the desired length to provide a support beam 11 for the vehicle in which it is intended to mount the support assembly 10. The appropriate modules 25, 40, 50, 55, 60, 70, 80, 90 are then provided as desired to provide support brackets for the elements to be supported by tile support assembly 10 and as appropriate for the vehicle of which tile dashboard assembly 10 is to form a part. The appropriate modules are mounted oil the beam 11 by engaging tags with the appropriate grooves 14a, 15a, 16a, 17a to provide the desired orientation of each module and then sliding the tags into the respective groove in a longitudinal direction. The module is then slid along the support beam 11 in a longitudinal direction until it reaches its desired location. The module is then connected in place by for example, welding, riveting or bolting, vibration bonding or adhesive bonding or by any other means as desired. The support assembly is assembled preferably by a robot jig but may be wholly or partly manually assembled if desired. Mounting means 20 are then provided at each end of the support beam 11. The support assembly 10 is then be introduced into the vehicle body and attached thereto by means of fasteners passing through the holes 22. Where a strengthening bracket 90 is provided, the bracket 90 may be connected to the appropriate rail of the vehicle body.

The high degree of flexibility and adaptability of the support beam assembly 10 provided by the current invention will be apparent. It will be clear the assembly 10 may be adapted for mounting in any appropriate vehicle, and may receive appropriate modules disposed at a desired orientation and at any location along the length of the beam 11. Although the grooves 14a, 15a, 16a, 17a and associated tags are shown as having the same shape or cross-section, it will be appreciated that different grooves and/or tags may be provided with differing cross-sections or shapes as desired.

In the present specification “comprise” means “includes or consists of” and “comprising” means “including or consisting of.”

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

While the invention has been specifically described in connection with certain specific embodiments thereof, it is to be understood that this is by way of illustration and not of limitation, and the scope of the appended claims should be construed as broadly as the prior art will permit.

What is claimed is:

1. A support assembly for a vehicle dashboard comprising a support beam, said support beam comprising a plurality of grooves disposed peripherally of said support beam, each groove extending longitudinally of the support beam, to support at least one dashboard module in a selected one of a plurality of positions.

2. A support assembly according to claim 1 wherein at least one of said grooves is T-shaped in cross-section.

3. A support assembly according to claim 1 wherein at least one of said grooves is dove-tailed in cross-section.

4. A support assembly according to any one of claims 1 to 3 wherein the grooves have the same cross-section.

5. A support assembly according to any one of claims 1 to 4 wherein the beam comprises at least three grooves.

6. A support assembly according to any one of claims 1 to 5 wherein the support beam comprises an extruded profile.

7. A support assembly according to claim 6 wherein the extruded profile is hollow and is filled with a foam material to provide additional stiffness.

8. A support assembly according to claim 6 or claim 7 wherein the extruded profile comprises a polymer material provided with reinforcing fibres.

9. A support assembly according to claim 6 or claim 7 wherein the extruded profile comprises a light metal or alloy.

10. A support assembly according to any one of the preceding claims wherein the support beam is polygonal in cross-section, with said grooves provided in a plurality of sides of said polygon.

11. A support assembly according to claim 10 wherein, in cross-section, the beam has five side faces, comprising a forward face, an upper face, a lower face, an upper rearward face and a lower rearward face wherein grooves are provided on the top, bottom and rearward sides.

12. A support assembly according to any one of the preceding claims comprising mounting means having a first pail for attachment to a vehicle body and a second part in engagement with said support beam.

13. A support assembly according to claim 12 wherein the mounting means comprises a plurality of tags each adapted to engage a corresponding groove of the said support beam.

14. A support assembly according to claim 12 or claim 13 where dependent directly or indirectly on claim 11 wherein the mounting means has a forward face which is generally coplanar with the forward side of said support beam.

15. A support assembly according to any one of the preceding claims comprising a dashboard module wherein said dashboard module comprises at least one tag to be received in at least one of said grooves.

16. A support assembly according to claim 15 wherein the dashboard module is disposed at a desired longitudinal location on the support beam by engaging the or each tag with a corresponding groove in a longitudinal direction and sliding the dashboard module relative to the beam until the dashboard module is in its desired position.

17. A support assembly according to claim 16 wherein the dashboard module is attached to the support beam when said module is in its desired position.

18. A support assembly according to claim 17 wherein the dashboard module is attached to the support beam by one of high frequency welding, vibration bonding, riveting or adhesive bonding.

19. A support assembly according to any one of claims 15 to 18 wherein the dashboard module comprises a contact surface to engage a face of said support beam.

20. A support assembly according to claim 19 wherein the contact surface comprises a flange disposed adjacent to said at least one tag.

21. A support assembly according to any one of claims 15 to 20 wherein the dashboard module is shaped to provide energy absorption properties.

22. A support assembly according to claim 21 wherein to provide said energy absorption properties, the dashboard module comprises a first connecting part provided said at least one tag and a second connecting part, and an intermediate part located between the first connecting pall and the second connecting pail, wherein the first connecting pail is connected to the intermediate part by a forward pair of arms and the second connecting part is connected to the intermediate pail by a rearward pair of arms.

23. A support assembly according to any one of claims 15 to 22 wherein the dashboard module is made by moulding, or extrusion.

24. A support assembly according to any one of claims 15 to 22 wherein the dashboard module comprises polymer or an alloy material.

25. A support assembly according to claim 23 or claim 24 wherein the dashboard module comprises a cavity and said cavity is filled with a foam material.

26. A support assembly according to any one of claims 15 to 25 wherein the dashboard module comprises one of an instrument support bracket, a ventilation support bracket, a steering column support bracket, an air bag support, a glove box support or a structural bracket to engage a part of vehicle.

27. A support assembly substantially as described herein and/or with reference to the accompanying drawings.

28. A method of making a support assembly comprising the steps of providing a support beam comprising a plurality of grooves disposed peripherally and extending longitudinally of said support beam, providing at least one dashboard module comprising at least one tag, engaging the or each tag with a corresponding groove in a longitudinal direction and sliding the dashboard module relative to the beam until the dashboard module is in its desired position.

29. A method according to claim 28 comprising the step of providing a support beam of a desired length before or after providing said at least one dashboard module.

30. A method according to claim 29 comprising the step of providing said support beam of a desired length by cutting a stock beam to the desired length.

31. A method according to claim 28, claim 29 or claim 30 further comprising fixing the dashboard module to the support beam when said dashboard module is in its desired position.

32. A method according to any one of claims 28 to 31 further comprising providing mounting means having a first part in engagement with said support beam and a second pail for attachment to a vehicle body.

33. A method according to claim 32 comprising the step of fixing said mounting means to a vehicle body.

34. A method substantially as described herein and/or with reference to the accompanying drawings.

35. Any novel feature or combination of features disclosed herein and/or in the accompanying drawings.
